(19) United States
(12) Patent Application Publication
(10) Pub. No.: US 2026/0264005 A1
(43) Pub. Date: Sep. 10, 2026

(54) METHOD AND APPARATUS FOR COOLING AND COMPRESSING A FLOW CONTAINING CO2 AND WATER

(71) Applicant: L'Air Liquide, Société Anonyme p0our I'Etude et I'Exploitation des Procédés Georges Claude, Paris (FR)

(72) Inventors: Mathieu LECLERC, Paris (FR); Maxime Rozieres, Charenton-le-Pont (FR); Gian Luigi Caloro, Verneuil I'Etang (FR); Charles Bignaud, Charenton-le-Pont (FR)

(21) Appl. No.: 19/559,038

(22) Filed: Mar. 6, 2026

(30) Foreign Application Priority Data
Mar. 10, 2025 (FR) FR2502360

(51) Int. Cl. B01D 53/26

(52) U.S. Cl. CPC B01D 53/265; B01D 53/261; B01D 2257/302; B01D 2257/404; B01D 2257/80

(57) ABSTRACT

In a method for cooling, compressing and cooling a gas containing at least 15 mol % of CO₂, the following steps are carried out: bringing the gas (1) that is cooled into direct contact (T) with water (5) that is heated forming heated water (11), cooling the pumped heated water to generate water in a cooling system, the cooling system comprising: an indirect-contact heat exchanger (HX 1) that exchanges heat between the pumped heated water and a flow of cooling water (17) of the cooling water system and a tower (CT) for cooling by direct contact with air to cool at least one portion of the cooling water upstream of the heat exchanger, with use of condensates (9) of a compressor of the gas cooled by the contacting as make-up of water for the cooling system.

### CROSS REFERENCE TO RELATED APPLICATIONS

This application claims the benefit of priority under 35 U.S.C. § 119 (a) and (b) to French Patent Application No. FR 2502360, filed Mar. 10, 2025, the entire contents of which are incorporated herein by reference.

### BACKGROUND

The present invention relates to a method and to an apparatus for cooling and compressing a flow containing CO₂ and water. The flow preferably contains at least 15 mol %, preferably at least 30 mol %, of CO₂ on a dry basis as well as water and at least one impurity such as at least one NOx and/or at least one SOx.

Units for capturing and purifying CO₂ from wet and hot sources (flue gases for example) usually comprise a step of cooling by direct contact with water. This step also enables the separation of a significant portion of the water contained in the source. It is combined with at least one compression and cooling step when the CO₂ separation process requires an increase in pressure in order to remove a portion of the remaining water. A step of drying by adsorption, for example, can be used to remove the remaining water.

It is conventional to perform cooling by bringing water into contact with the hot source, the water obtained at the bottom of the contactor being pumped and cooled against a cold source before being reinjected into the contactor. This water obtained at the bottom is typically laden with dust and with impurities that have been scrubbed out. This is particularly the case when the hot source is a combustion flue gas or a flue gas from a cement or lime production unit. It is then necessary to purge a portion of the water obtained in order to limit the concentration of dust and impurities that could lead to problems of fouling or deposition in the water recirculation loop. In the case of a hot source that is highly concentrated in water, the condensation of the water may be sufficient to make up for this purge. In the case of a hot source that is not very highly laden in water, an external make-up of water is then necessary. The cold source is typically cooling water generated by indirect air coolers or by towers for cooling in direct contact with air or may be seawater. In this configuration, a water/water heat exchanger is then used. In some cases, the water obtained at the bottom is cooled directly by indirect air coolers.

The water resulting from the condensation of the steam contained in the gases containing the CO₂ to be purified is purged to a treatment station before reuse or discharge into the natural environment. It is known from FR3128384 to use a process for scrubbing a gas flow, in which: a gas flow comprising at least one NOx and/or at least one SOx and/or suspended matter and at least 15 mol % of CO₂ on a dry basis is sent to a scrubbing tower in which it is cooled and scrubbed with water and/or with an alkaline liquid to produce a gas enriched in CO₂ at the top of the tower and a bottom liquid enriched in the at least one NOx and/or the at least one SOx and/or suspended matter at the bottom of the tower.

U.S. Pat. No. 7,993,615 describes a contacting tower of which the make-up water comes from an unidentified source.

US2013/0098104 uses two towers in series that act as the tower for bringing the gas to be cooled into contact with water, but does not describe an air-cooling tower to cool the water. The document does not indicate how the heat energy transferred from the flue gases to the water is dissipated.

In the case of compression and drying after the cooling step, it is important to minimize the temperature of the cold source in order to limit the temperature at the inlet of the compressor and in order to condense as much water as possible prior thereto. This makes it possible to limit the size of the compressor and the energy required for the compression and drying.

However, indirect air coolers are relatively inefficient when it comes to cooling as much as possible because they involve a relatively high difference between the dry bulb temperature of the air and that of the cooled fluid (typically 10° C.). Towers for cooling in direct contact with air allow an approach to the wet bulb temperature (much lower than the dry bulb temperature) but require a significant make-up of water because a significant portion of the water is evaporated during the heat exchange. This amount of water is typically not available even in relatively wet flue gases.

The use of a water/water exchanger also increases the temperature difference between the air (wet or dry bulb) and the cooled flue gases.

By evaporating a portion of the water, the invention also makes it possible to reduce the flow of water that is sent to the treatment station, thus making it possible to reduce the dimensions and cost thereof.

The water circulating through an air-cooling tower contains impurities that could be emitted into the air (due to the direct contact) in the form of aerosols for example. According to the invention, a dedicated loop makes it possible to regulate the composition of the water by means of the quality of the make-up that comes from the condensate treatment system. Thus, the amounts of impurities sent into the air are extremely low.

### SUMMARY

The invention consists in minimizing evaporation and increasing the make-up of water of the system in order to ensure the operation of a direct-contact cooling tower.

According to one subject of the invention, what is provided is a method for cooling, compressing and cooling a gas containing at least 15 mol % of CO₂ and water, comprising the following steps:
bringing the gas that is cooled into direct contact with water, at a first temperature, colder than the gas, that is heated forming heated water
pumping the heated water
cooling the pumped heated water to generate water at the first temperature in a cooling system, the cooling system comprising:
   an indirect-contact heat exchanger that exchanges heat between the pumped heated water and a flow of cooling water of the cooling water system and a tower for cooling by direct contact with air to cool at least one portion of the cooling water upstream of the heat exchanger, the water cooled in the cooling tower being returned to the heat exchanger
compressing the cooled gas by contacting in a compressor to produce a compressed fluid containing CO₂ and water
cooling the compressed gas and partially condensing the water that it contains forming condensed water and a flow of water-depleted gas and
using at least one portion of the condensed water as make-up of water for the cooling system, optionally after treatment in a treatment unit for purifying the condensed water.

An objective of the invention is to generate water from the CO₂ capture process with a sufficient quality to be able to use it in a cooling tower. This idea has the advantage of not extracting water from the natural environment. In a CO₂ capture apparatus, liquid water is often generated at three locations: in the tower for bringing the gas to be treated into direct contact with the water, then in the compressor and in the dryer downstream of the tower. These three condensates are sent to a water treatment station in order to be purified. However, the majority of the water comes from the direct-contacting tower (more than 50%). This water is used as make-up liquid in a semi-open water-cooling loop.

According to the invention, the make-up of water for the cooling circuit comes from the hot part of a CO₂ separation unit, making it possible to reduce, or even avoid, consumption of water from local sources, which is prohibited in many countries with shortages of water.

According to other optional characteristics:
the flow of cooling water, heated in the heat exchanger upstream of the air-cooling tower or to be heated in the heat exchanger downstream of the cooling tower, is cooled in a cooling means
the cooling means is an air cooler that cools the water by direct contact with air
the cooling means is another indirect-contact heat exchanger that receives cold energy from another cooling circuit
the other cooling circuit is a cooling circuit of the compressor
the process comprises the steps of drying the flow of water-depleted fluid by adsorption and condensation of the adsorbed water vapour
at least one portion of the at least one portion of the condensed water is treated to reduce its acidity before being sent to the cooling system
at least one portion of the at least one portion of the condensed water is not treated before being sent to the cooling system
a make-up flow of water is formed by mixing the water treated in the treatment unit and at least one condensate not treated in the treatment unit and optionally a purge flow not treated in the treatment unit to regulate the acidity level of the make-up flow
a portion of the cooling water circulates in the cooling system without passing through the air-cooling tower
the amount of water circulating in the cooling system without passing through the air-cooling tower is regulated depending on the make-up flow.

According to another subject of the invention, what is provided is an apparatus for cooling, compressing and cooling a gas containing at least 15 mol % of CO₂ and water, comprising:
means for bringing the gas that is cooled into direct contact with water, at a first temperature, colder than the gas, that is heated forming heated water
a pump connected to pressurize the heated water producing pumped heated water
a system for cooling the heated water to generate water at the first temperature, the cooling system comprising:
   an indirect-contact heat exchanger that exchanges heat between the pumped heated water and a flow of cooling water of the cooling water system and a tower for cooling by direct contact with the air to cool at least one portion of the cooling water upstream of the heat exchanger, the tower being connected to the heat exchanger to return the water cooled in the tower to said heat exchanger
means for compressing the cooled gas in the contacting means to produce a compressed fluid containing CO₂ and water
a cooler for cooling and partially condensing a gas compressed by the compression means and a phase separator for separating the partially condensed gas forming condensed water and a flow of water-depleted gas and
a pipe connected to the phase separator for sending at least one portion of the condensed water as make-up of water for the cooling system, optionally connected to a treatment unit for purifying the water.

According to other optional characteristics:
a cooling means is connected to cool the flow of cooling water, heated in the heat exchanger upstream of the cooling tower or to be heated in the heat exchanger downstream of the cooling tower, in a cooling means
the cooling means is an air cooler that cools the water by direct contact with air
the cooling means or another indirect-contact heat exchanger that receives cold energy from another cooling circuit
the other cooling circuit optionally that is a cooling circuit of the compression means
the cooling cycle is a semi-open cycle
the cooling system is the only means for cooling the heated water
all heated and cooled water is returned to the contacting means
the apparatus comprises a treatment station common to the condensates of the compression of the gas coming from the contacting means and from the cooling system
the apparatus comprises a treatment station common to the condensates of the compression of the gas coming from the contacting means, from the cooling system and from the circuit for returning heated water cooled by the cooling system
the cooling system comprising the indirect-contact heat exchanger that exchanges heat between the pumped heated water and the flow of cooling water of the cooling water system and the tower for cooling by direct contact forms a semi-open loop.

According to one subject of the invention, what is provided is a method for separating a flow containing CO₂ and water comprising a cooling and compression method as described above, the gas compressed in the compressor then being purified to remove water, cooled and separated by partial condensation and/or distillation and/or solidification to produce a CO₂-rich flow containing for example at least 90 mol % of CO₂. Optionally, the dried flow is separated by pressure swing adsorption to enrich the flow in CO₂ upstream of the separation by partial condensation and/or distillation and/or solidification.

Part of the indirect cooling can be by means of indirect air coolers or cooling-water (optionally seawater) exchangers. This indirect cooling can be removed if the evaporation in the tower for cooling in direct contact with the air is less than the make-up of water for the system (in particular if an external make-up is considered).

The condensates used as make-up can be treated in order to remove the impurities that they contain before injection into the cooling circuit. It is possible for example to filter them, or treat them chemically (neutralization, anti-scale treatment, reverse osmosis).

The cooling circuit consists of a parallel loop that exchanges heat with indirectly heated water. The purge from this parallel loop can be sent to the condensate treatment system to minimize losses of water.

It is possible to use a portion of the acidic condensates as make-up by bypassing the treatment system. The pH thereof makes it possible to increase the number of concentration cycles because a low pH increases the solubility of CaCO₃. Instead of sending all the condensates 9 generated downstream of the contacting means T to the treatment station WWT and then to the dedicated cooling system HX1, P2, CT, a portion 15A of the condensates can be sent directly to the system because they are acidic and make it possible to limit scale deposits. They can be injected at different locations (mixing in pipework for example) but it is preferable to send them into the basin of the cooling tower CT.

In the case where the make-up is insufficient, a portion of the water intended for the water-cooling tower can bypass the tower to minimize the flow passing through it and therefore evaporation. In this case, the water will only be cooled to an intermediate temperature.

These configurations enable a minimization of the temperature of the water used to cool the hot source while minimizing (or even eliminating) the need for a make-up of water from an external source. The consequences are as follows:
lower flow of water circulating to cool the hot source (since the water is colder, less water is needed), minimizing the size of the equipment throughout the loop
minimization of the energy of the downstream compressor due to the lower temperature as well as its size (lower volume flow rate to be treated)
increased condensation of the water contained in the hot source, minimizing the energy of the downstream compressor as well as its size (lower mass flow rate to be treated)
increased condensation of the water contained in the hot source, minimizing the cooling demand for the intermediate exchangers of the compressor because less water is condensed therein.

If the cooling circuit contains a combination of at least one indirect air cooler upstream or downstream of the at least one tower CT for cooling in direct contact with air, this makes it possible to minimize the temperature at the inlet of the at least one cooling tower and therefore the heat rejected there, making it possible to minimize evaporation and therefore the need for a make-up of water. This make-up is largely generated by the process itself during the compression, cooling and/or drying of the hot source.

### BRIEF DESCRIPTION OF THE DRAWING

For a further understanding of the nature and objects for the present invention, reference should be made to the following detailed description, taken in conjunction with the accompanying drawing, in which like elements are given the same or analogous reference numbers and wherein:

FIG. 1 shows a method according to the invention.

### DETAILED DESCRIPTION OF THE PREFERRED EMBODIMENTS

A flow containing at least 15 mol % of CO₂, or even at least 30 mol % of CO₂, on a dry basis, water, solid particles and at least one impurity, such as an SOx and/or an NOx, 1 is sent into a scrubbing tower T where it is scrubbed with a flow of water optionally containing sodium hydroxide NaOH. Preferably, the acidity level is measured upstream of the pump P1 in a pH analyser. This has the effect of purifying the flow 1 and cooling it. The flow 3 that has been cooled and purified of particles and of SOx and/or NOx is heated in a heat exchanger R1 with water and then is compressed by at least one compression step C1 followed by at least one cooling step R2; the compression and/or the cooling condenses the remaining water 9 present in the flow 3, this water being acidified by the presence of NOx and/or SOx and of CO₂ and being called condensate. The dried flow 7 is further dried by adsorption in a unit of TSA type (not illustrated). After drying of the flow of water-depleted fluid by adsorption, the condensation of the adsorbed water vapour allows the use of the condensed water as make-up for the cooling system.

The condensate 9 is sent to a treatment unit WWT where it is purified to remove the at least one acid that it contains as well as possibly the remaining solid particles. Brine B leaves the unit WWT and can be reused or discharged into the natural environment. The unit WWT also produces a make-up flow of purified water 21.

A flow of water containing solid particles and enriched in SOx and/or NOx is withdrawn from the bottom of the scrubbing tower T, pressurized in a pump P1 and then cooled in an indirect heat exchanger HX1. The cooled water 13 is sent to the top of the scrubbing tower T optionally after addition of sodium hydroxide. A portion 15 of the water can be diverted at least occasionally as purge and sent to the treatment unit WWT to be treated. Thus, the treatment unit WWT is common to the condensates 9 and to the scrubbing tower T. The treatment unit WWT may be common to the condensates 9 of the compression of the gas coming from the contacting means M, from the cooling system and from the circuit for returning heated water 13 cooled by the cooling system.

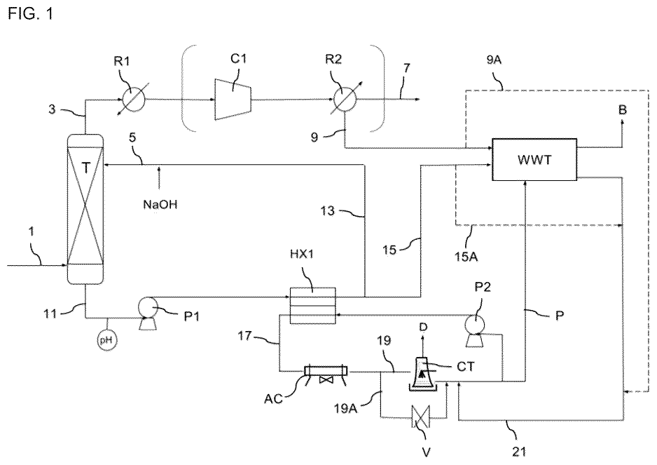

Thus, it can be seen that the flows 9, 15 and P are sent to the unit WWT to be treated for example to reduce their acidity. The heat exchanger HX1 is cooled by a semi-open cooling circuit with a make-up of water 21 coming from the treatment unit WWT and a purge P also sent to the unit WWT. The cooling of the circuit is obtained by a water-cooling tower in direct contact with air CT optionally preceded or followed by a cooler in direct contact with air AC. As illustrated in FIG. 1, water is introduced into the tower to flow downwards in counter-current with atmospheric air.

The cooler AC can be replaced by an indirect-contact heat exchanger connected to another cooling circuit, for example a cooling circuit of the at least one compression step C1 in a compressor. The water 17 heated in the exchanger HX1 arrives directly at the tower CT or is cooled by the cooler AC before arriving at the tower CT or downstream of the tower CT. The water sent into the tower CT escapes partly diluted in the air from the cooler AC if present and partly in the form of aerosols at the top of the tower CT as flow D entrained by the air and the rest of the water 19 is divided into two, one portion P being sent to the treatment unit WWT and another portion being mixed with the make-up flow 21 to compensate for the losses of steam D. The cooled water is recirculated to the heat exchanger HX1 by a pump P2.

A portion 9A of the condensate can be sent directly to the cooling system CT, HX1, P2 without passing through the treatment unit WWT. It is preferably mixed with the make-up flow 21.

A portion 15A of the purge 15 can also be sent to the cooling system without passing through the treatment unit WWT. It is preferably mixed with the make-up flow 21.

A portion 19A of the water 12 can bypass the air-cooling tower CT by passing through the open valve V. Preferably, the amount of water 19A circulating in the cooling system without passing through the cooling tower is regulated depending on the make-up flow 21.

In the case where the make-up 21 is insufficient, a portion of the water 19A intended for the water-cooling tower can bypass the tower CT to minimize the flow 19 passing through it and therefore evaporation D. In this case, the water will only be cooled to an intermediate temperature.

Otherwise, if the flow rate of the make-up flow 21 decreases, the flow 19A increases.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method for cooling, compressing and cooling a gas containing at least 15 mol % of CO₂ and water (1), comprising the following steps:
bringing the gas (1) into direct contact (T) with water (5), at a first temperature,
colder than the gas, forming a heated water (11),
pumping (P1) the heated water (11),
cooling the pumped heated water to generate water at the first temperature in a cooling system, the cooling system comprising:
an indirect-contact heat exchanger (HX 1) that exchanges heat between the pumped heated water and a flow of cooling water (17) of the cooling water system and a tower (CT) for cooling by direct contact with air to cool at least one portion of the cooling water (17) upstream of the heat exchanger, the water cooled in the cooling tower being returned to the heat exchanger,
compressing the cooled gas by contacting in a compressor (C1) to produce a compressed fluid containing CO₂ and water,
cooling (R2) the compressed gas and partially condensing the water that it contains forming a condensed water (9) and a flow of water-depleted gas (7), and
using at least one portion (21) of the condensed water (9) as a make-up water for the cooling system.

2. The method according to claim 1, further comprising the cooling of the flow of cooling water, heated in the heat exchanger (HX 1) upstream of the air-cooling tower (CT) or to be heated in the heat exchanger downstream of the cooling tower, in an air cooler (AC) that cools the water by direct contact with air or another indirect-contact heat exchanger that receives cold energy from another cooling circuit, optionally which is a cooling circuit of the compressor.

3. The method according to claim 1, further comprising the steps of drying the flow of water-depleted fluid (7) by adsorption and condensation of the adsorbed water vapour.

4. The method according to claim 1, in which at least part of the at least one portion (9A) of the condensed water is treated (WWT) in a treatment unit to reduce its acidity before being sent to the cooling system.

5. The method according to claim 4, in which at least part of the at least one portion (9A) of the condensed water is not treated before being sent to the cooling system.

6. The method according to claim 4, in which a make-up flow of water is formed by mixing the water treated in the treatment unit (WWT) and at least one condensate not treated in the treatment unit to adjust the acidity level of the make-up flow of water to a desired target pH or pH range.

7. The method according to claim 1, in which a portion of the cooling water (19A) circulates in the cooling system without passing through the air cooling tower (CT).

8. The method according to claim 7, in which the amount of water circulating in the cooling system without passing through the air cooling tower (CT) is regulated depending on the make-up flow of water.
